(19) United States
(12) Patent Application Publication
(10) Pub. No.: US 2012/0033090 A1
(43) Pub. Date: Feb. 9, 2012

(54) NETWORK CAMERA, OPERATION CONTROL METHOD, AND RECORDING MEDIUM

(75) Inventor: Yuki Kogure, Minato-ku (JP)

(73) Assignee: NEC CORPORATION, Minato-ku, Tokyo (JP)

(21) Appl. No.: 13/262,144

(22) PCT Filed: Mar. 15, 2010
(86) PCT No.: PCT/JP2010/054755

§ 371 Date: Sep. 29, 2011

(30) Foreign Application Priority Data
Mar. 30, 2009 (JP) 2009-080773

(51) Int. Cl. H04N 5/225

(52) U.S. Cl. 348/207.1; 348/E05.024

(57) ABSTRACT

The object of the present invention is to provide a network camera, an operation control method and a program that can improve convenience.

A network camera of the present invention is a network camera that can be connected to a network, and is equipped with: an image capturing means for capturing an image of an object and generating image data, an image processing means for encoding the image data, a storing means for storing the image data encoded by the image processing means, and a controlling means for controlling an encoding bit rate at the image processing means based on a data transmission rate that the network has allowed for the network camera.

### TECHNICAL FIELD

The present invention relates to a network camera, an operation control method and a recording medium, and more specifically relates to a network camera that can store captured image data in a server connected via a network.

### BACKGROUND ART

In recent years, communications infrastructure is being upgraded by the establishment of public wireless LAN (Local Area Network), the improvement in speed of mobile communication, and the establishment of technology to ensure the quality of communications such as QoS (Quality of Service). Further, by the public wireless LAN, the speeding up of the mobile communications, and the expansion of coverage area, indoors and outdoors use of high-speed wireless network communications has become possible. For this reason, a basis of the spread of network video cameras is being formed. However, because mobile communication networks and public wireless LAN are building a communicable area called a cell by making base stations be scattered, there is a problem that a valley occurs between each of the communication area.

An invention related to a network camera, for example, is disclosed in patent literature 1, 2, and 3.

The network camera disclosed in patent literature 1 can store image data to a server located at homes via a wireless network (network storage). Accordingly, the user, even when outside the home, can perform image capturing, without depending on the storage capacity of the physical medium, However, when the user moves out of the cell mentioned above, data cannot be stored via the network. Further, when a cell which includes many mobile stations including a network camera exist, such as athletic festivals and recitals, a plurality of mobile stations will share a band of the cell. Therefore, in such case, a band for one mobile station becomes small.

In such case, the user temporarily stores image data in a physical memory in the network camera, and when a band can be secured, the user has to upload image data to a server. Further, by a shortage of memory capacity, the user may even have to cancel image capturing. Thus, in patent literature 1, the situation that cannot take advantage of the network storage may occur.

Furthermore, when there is a problem in recording data by a network camera, a data acquisition apparatus disclosed in patent literature 2 designates other network camera having available empty memory, as an alternative recording apparatus. That is, in patent literature 2, it is supposed that there is a plurality of network cameras. Therefore, it is not possible to improve convenience, when there is only one network camera.

On the other hand, when it is impossible to transmit, a moving image communication device disclosed in patent literature 3, generates a moving image with a lower image picture quality than at the transmittable time. That is, when it is impossible to transmit because the moving image communication device is out of the service area, moving image data size to be generated is reduced. As a result, it is possible to control cancelling image capturing due to a shortage of memory capacity.

### CITATION LIST

### Patent Literature

[Patent Literature 1] Japanese Patent Application Laid-Open No. 2004-187106

[Patent literature 2] Japanese Patent Application Laid-Open No. 2007-166181

[Patent literature 3] Japanese Patent Application Laid-Open No. 2008-311831

### SUMMARY OF INVENTION

### Technical Problem

However, in patent literature 3, the moving image is generated with a low picture quality only at the non-transmittable time. Therefore, when it can be transmitted but in a case when the communication status is bad, an interruption of image capturing due to a shortage of memory capacity occurs and lacks convenience.

The object of the present invention is to solve the problems mentioned above, and provide a network camera, an operation control method and a recording medium that can improve convenience.

### Solution to Problem

A network camera of the present invention is a network camera which can be connected to a network, including: an image capturing means for capturing an image of an object and generating image data; an image processing means for encoding the image data; a storage means for storing the image data encoded by the image processing means; and a controlling means for controlling an encoding bit rate at the image processing means based on a data transmission rate that the network has allowed for the network camera.

An operation control method of the present invention is an operation control method of a network camera which can be connected to a network, including: an image capturing step for capturing an image of an object and generating image data; an image processing step for encoding the image data; a storing step for storing the image data encoded by the image processing step in a storage means; and a controlling step for controlling an encoding bit rate at the image processing step based on a data transmission rate that the network has allowed for the network camera.

A program of the present invention is a program that makes a computer to execute operation control method of a network camera which can be connected to a network, characterized by having a computer to execute: an image capturing processing for capturing an image of an object and generating image data; an image processing for encoding the image data; a processing for storing the image data encoded by the image processing in a storage means; and a controlling processing for controlling an encoding bit rate at the image processing based on the data transmission rate that the network has allowed for the network camera.

A recording medium of the present invention is a recording medium that records a program that makes a computer to execute the operation control method of the network camera that can be connected to a network, characterized by having a computer to execute: an image capturing process for capturing an image of an object and generating image data; an image process for encoding the image data; a process for storing the image data encoded by the image process in a storage means; and a controlling process for controlling an encoding bit rate at the image process based on a data transmission rate that the network has allowed for the network camera.

### Advantageous Effects of Invention

According to the present invention, convenience of a network camera can be improved.

### BRIEF DESCRIPTION OF DRAWINGS

FIG. 1 is a diagram showing a schematic configuration of a network camera for describing a principle according to a first exemplary embodiment of the present invention.

FIG. 2 is a diagram showing a configuration of the network camera according to the first exemplary embodiment of the present invention.

FIG. 3 is a flowchart showing an operation of the network camera of FIG. 2.

FIG. 4 is a diagram illustrating an operation of the network camera of FIG. 2.

FIG. 5 is a diagram illustrating an operation of the network camera of FIG. 2 when the user sets the highest rate for the encoding bit rate.

### DESCRIPTION OF EXEMPLARY EMBODIMENTS

The exemplary embodiments of the present invention will be described with reference to the drawings. However, the exemplary embodiments are not intended to limit the technical scope of the present invention.

### A First Exemplary Embodiment

A first exemplary embodiment of the present invention will be described with reference to the drawings.

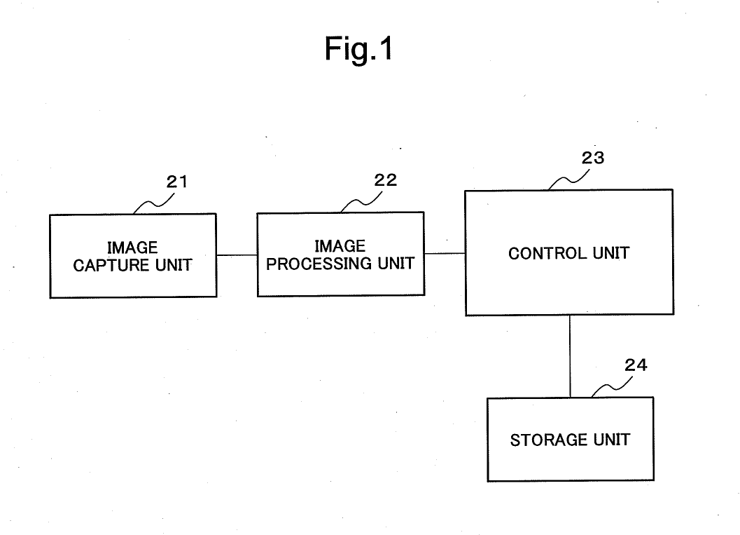

First, a principle of the exemplary embodiment will be described with reference to FIG. 1. FIG. 1, for describing a principle of the exemplary embodiment, shows schematic configuration of a network camera.

The network camera shown in FIG. 1 can store image data in a server which is not illustrated connected via a network. The network camera includes an image capture unit 21, an image processing unit 22, a control unit 23, and a storage unit 24.

The image capture unit 21 captures an image of an object and generates image data. The image processing unit 22 encodes the image data which the image capture unit 21 generated. The control unit 23 controls the encoding bit rate in the image processing unit 22, according to the data transmission rate that a network has allowed for the network camera. Further, the control unit 23 controls the image processing unit 22 and the storage unit 24, in order to have the image data encoded by the image processing unit 22 to be stored in the storage unit 24.

As mentioned above, the control unit 23 is configured to change the encoding bit rate dynamically, according to the data transmission rate that a network has allowed for the network camera. Therefore, although the data can be transmitted but in a case when the transmission rate is low, it is possible to control an interruption of image capturing due to a shortage of storage capacity of the storage unit 24. As a result, convenience of a network camera can be improved.

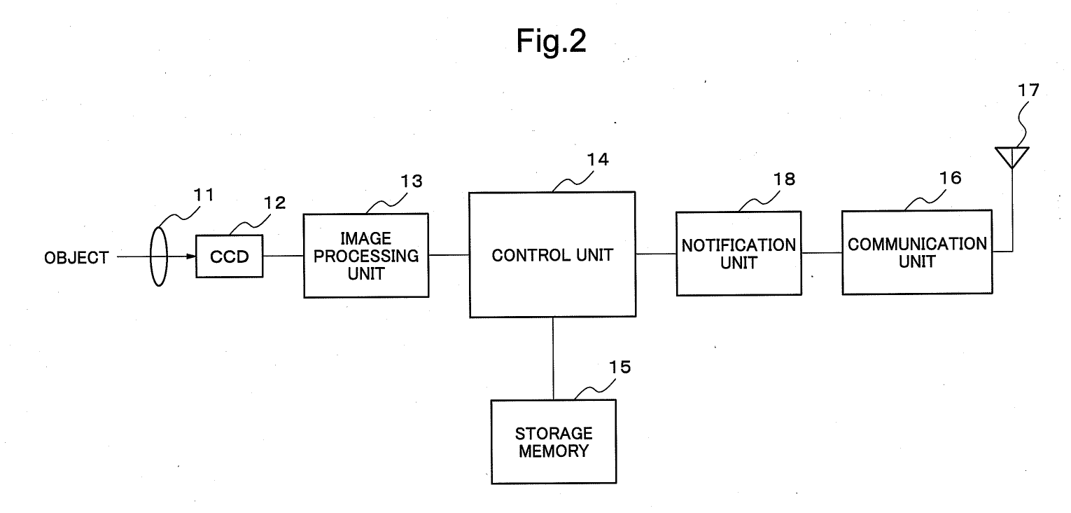

Next, a configuration of the present exemplary embodiment will be described with reference to FIG. 2.

FIG. 2 is a figure showing a configuration of the network camera according to the present exemplary embodiment. The network camera of the present exemplary embodiment is a mobile station of a radio communication system. The network camera of the exemplary embodiment includes a lens 11, a CCD (Charge Coupled Device) 12, an image processing unit 13, a control unit 14, a storage memory 15, a communication unit 16, an antenna 17, and a notification unit 18.

The lens 11 forms an image by capturing light from an object. The CCD 12 converts the formed image into an electric signal. The image processing unit 13 A/D converts the electric signal and performs a compression coding process. The storage memory 15 is a RAM (Random Access Memory) temporarily storing data of a moving image compressed by the image processing unit 13 or a still image. The compression method of a moving image by the image processing unit 13, for example, is an MPEG (Moving Picture Experts Group)-2 or H.264/MPEG-4 AVC (Advanced Video Encoding) (AVCHD (AVC High Definition)). Further, the compression method of a still image by the image processing unit 13, for example, is a JPEG (Joint Photographic Experts Group). The control unit 14 stores data from the image processing unit 13 in the storage memory 15. Furthermore, the control unit 14 connects with the network and performs communications, via a base station of a wireless network which is not illustrated, by using the communication unit 16 and the antenna 17. The network camera of the present exemplary embodiment can store data of the storage memory 15 in a server which is not illustrated, via the network.

Further, the control unit 14 performs variable control of the encoding bit rate in the image processing unit 13, according to the data transmission rate that a base station has allowed for the network camera and the remaining amount of the storage capacity of the storage memory 15. In LTE (Long Term Evolution), mobile stations share an upstream band. The base station notifies the allowed band and modulation method, to each mobile station. The mobile stations perform data transmission to a base station using the notified band and the notified modulation method. In addition, mobile stations can find the transmission rate (bit rate) assigned to itself, based on the notified band and modulation method. As shown above, the control unit 14 finds the transmission rate that a base station has allowed for the network camera, and also confirms the remaining capacity of the storage memory 15. Then, the control unit 14 performs variable control of the encoding bit rate, according to the transmission rate and the remaining capacity of the storage memory 15. The notification unit 18 notifies predetermined information to the base station, for example the highest rate of the encoding bit rate set in the network camera, via the communication unit 16 and the antenna 17.

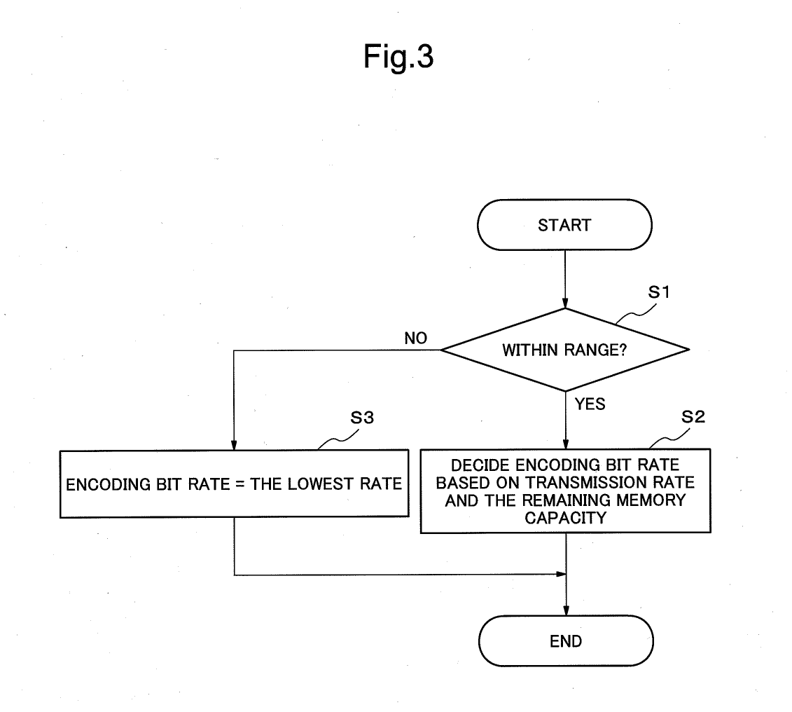

FIG. 3 is a flowchart showing an operation of the network camera of FIG. 2. The operation shown in FIG. 3 is, for example, conducted in a sampling interval of a short cycle. Further, it is also possible to set an image captured by the fixed encoding bit rate, which is designated by the user. In such case, the operation shown in FIG. 3, may be performed only when the user designated to start the operation.

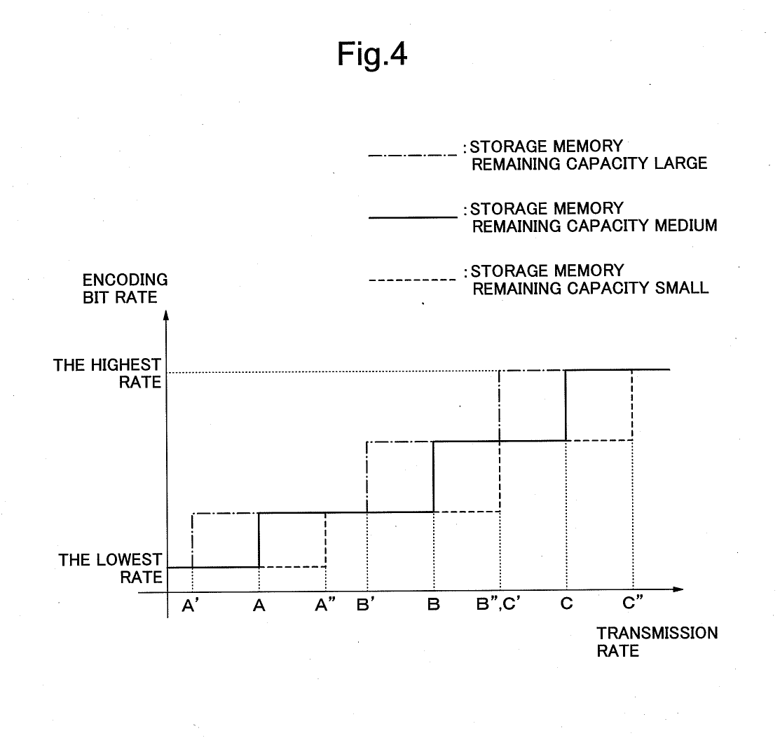

In FIG. 3, when a network camera is out of the cell range and cannot be transmitted (step S1/NO), the control unit 14 sets the encoding bit rate in the image processing unit 13 to the lowest rate (Step S3). On the other hand, when the network camera is within the cell range (step S1/YES), the control unit 14 performs variable control of the encoding bit rate, according to the transmission rate that a base station has allowed for the network camera and the remaining capacity of the storage memory 15 (Step S2). The processing operation of the Step S2 hereof will be described using FIG. 4.

The horizontal axis of a graph of FIG. 4 indicates the transmission rate that a base station has allowed for the network camera, and the vertical axis indicates the encoding bit rate. A dashed-dotted line, a solid line, and a short dashed line indicate the encoding bit rate for each remaining capacity of the storage memory 15. According to the present exemplary embodiment, the remaining capacity of the storage memory 15 is divided into three stages. That is, when the remaining capacity is “medium” the threshold values A, B, and C, when the remaining capacity is “large” the threshold values A′, B′, and C′, and when the remaining capacity is “small” the threshold values A″, B″, and C″ are used, respectively. In addition, the encoding bit rate is set to four stages. Further, the remaining capacity and the encoding bit rate may respectively be staged into smaller parts or be staged more roughly.

First, the case of the remaining capacity when “middle” of the storage memory 15 shown in FIG. 4 by a solid line will be described. When the transmission rate is lower than the threshold value A, the encoding bit rate is made to the lowest rate, in order to prevent the memory capacity to be filled, as same as Step S3. When the transmission rate is more than or equal to the threshold value A and it is lower than the threshold value B, or when the transmission rate is more than or equals to the threshold value B and it is lower than the threshold value C, the encoding bit rate is raised in stages. When the transmission rate is more than or equals to the threshold value C, the encoding bit rate is raised to the highest rate.

When the remaining capacity of the storage memory 15 indicated by the dashed-dotted line is “large”, the remaining capacity of the storage memory 15 has enough room for the remaining capacity more than when the capacity storage is “middle”. Therefore, the threshold values A′, B′, and C′ are set lower than the threshold values A, B, and C of the remaining capacity “middle”. On the other hand, when the remaining capacity of the storage memory 15 indicated by the short dashed line is “small”, the remaining capacity of the storage memory 15 do not have enough room in the remaining capacity than when the capacity storage is “middle”. Therefore, the threshold values A″, B″, and C″ are set higher than the threshold values A, B and C when the remaining capacity is “middle”. The control by the storage memory remaining capacity described as above, shows that it is desirable to control as the memory remaining capacity will be “middle”.

As it has been described above, the control unit 14 of the network camera according to the present exemplary embodiment dynamically changes the encoding bit rate according to the transmission rate that a base station has allowed for the network camera. Therefore, even when the data can be transmitted but in a case when the transmission rate is low, the control unit 14 will be possible to control an interruption of image capturing due to a shortage of the storage capacity of the storage memory 15. As a result, convenience of a network camera can be improved. Further, the control unit 14 takes not only the transmission rate but also the remaining capacity of the storage memory 15 into consideration to perform variable control of the encoding bit rate. Therefore, it is possible to control even more of the storage capacity of the storage memory 15 becoming insufficient.

Thus, the network camera according to the present exemplary embodiment can continue image capturing, even when the communication situation is bad. Therefore, a large-volume physical memory becomes unnecessary, and a price reduction and miniaturization of the body of a network camera become possible. Further, when the user wants to store by the high encoding bit rate even when the communication situation is bad, by the user's setting, it is possible not to have the operation of FIG. 3 be operated. Therefore, convenience of the user's image capturing method can be further improved.

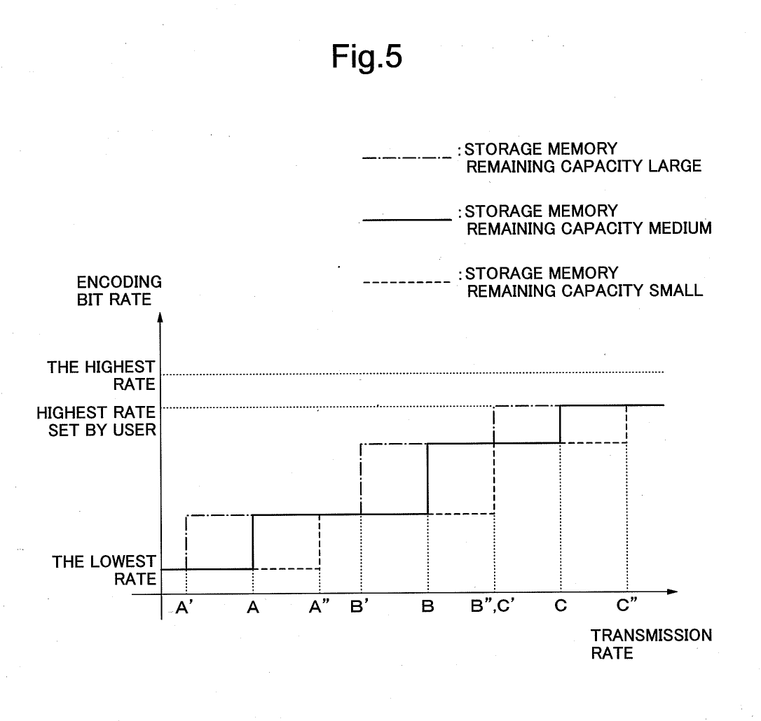

Further, according to the exemplary embodiment of the present invention, the user may set the highest rate of the encoding bit rate, referring to FIG. 4. FIG. 5 shows an operation when the user sets the highest rate of the encoding bit rate. When the user sets the highest rate of the encoding bit rate, the control unit 14 performs variable control of the encoding bit rate, having the highest rate that the user set as the maximum limit.

Further, the base station considers equity of the wireless environment and the transmission rate with other mobile stations, and determines the transmission rate (band and modulation method) to be assigned to a mobile station. Here, the base station, considers equity of the wireless environment and the transmission rate with the other mobile stations and determines the transmission rate, when not knowing the set highest rate. Therefore, there is a possibility that an excessive transmission rate to be assigned to a network camera. Accordingly, the control unit 14 may make the notification unit 18 notify the highest rate of the encoding bit rate set in a network camera to the base station. Further, when the notification unit 18 notifies the highest rate to the base station, the notification unit 18 notifies via the communication unit 16 and the antenna 17. Then, the base station may determine the transmission rate that is to be assigned to the network camera, as having the notified highest rate as the maximum limit. As a result, the base station can prevent the excessive transmission rate being assigned to the network camera.

Further, the operation of the network camera shown in FIG. 3, it is also possible to realize a program stored in advance in a storage medium such as ROM, by having a computer which becomes a control unit (CPU: Central Processing Unit) to read, in the network camera.

### A Second Exemplary Embodiment

A second exemplary embodiment of the present invention will be described.

A network camera in the present exemplary embodiment is a network camera that can store image data to a server connected via a network, and includes an image capturing means for capturing an image of an object, an image processing means for performing a compression coding to the image data of the image capturing means, a storing means for storing image data that is performed compression encoding by the image processing means, and a controlling means for performing a variable control of the encoding bit rate at the image processing means according to the data transmission rate that the network has allowed for the network camera.

Further, an operation control method of the present exemplary embodiment is an operation control method of the network camera that can store image data to a server via a network, and includes an image capturing step for capturing an image of an object, an image processing step for performing compression coding to the image data, a storing step for storing image data that is performed compression coding by the image processing step in the storage means, and a controlling step for performing a variable control of the encoding bit rate at the image processing step according to the data transmission rate that the network has allowed for the network camera.

Furthermore, a program of the present exemplary embodiment is a program that makes a computer to execute the operation control method of the network camera that can store image data to a server via a network, and includes an image capturing processing for capturing an image of an object, an image processing for performing compression coding to the image data, a processing for storing image data that is performed compression encoding by the image processing in the storage means, and a controlling processing for performing a variable control of the encoding bit rate at the image processing according to the data transmission rate that the network has allowed for the network camera.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2009-080773, filed on Mar. 30, 2009, the disclosure of which is incorporated herein in its entirety by reference.

### REFERENCE SIGNS LIST

11 lens
12 CCD
13, 22 image processing unit
14, 23 control unit
15 storage memory
16 communication unit
17 antenna
21 image capture unit
24 storage unit

1. A network camera which can be connected to a network, comprising:
an image capturing unit for capturing an image of an object and generating image data;
an image processing unit for encoding the image data;
a storage unit for storing the image data encoded by the image processing unit; and
a controlling unit for controlling an encoding bit rate at the image processing unit based on a data transmission rate that the network has allowed for the network camera.

2. The network camera according to claim 1,
wherein the control unit controls the encoding bit rate based on the data transmission rate and a remaining amount of storage capacity of the storage unit.

3. The network camera according to claim 1,
wherein the control unit sets the encoding bit rate to a predetermined rate when the network camera is out of service range of the network, and controls the encoding bit rate based on the data transmission rate when the network camera is within the service range of the network.

4. The network camera according to claim 2,
wherein the control unit sets the encoding bit rate to the predetermined rate when the network camera is out of the service range of the network, and controls the encoding bit rate according to the data transmission rate and the remaining amount of the storage capacity of the storing unit when the network camera is within the service range of the network.

5. The network camera according to claim 1, further comprising:
a notifying unit for notifying a highest rate of the encoding bit rate controlled by the control unit to the network,
wherein the notifying unit makes an upper limit of the data transmission rate that the network allows as the highest rate.

6. The network camera according to claim 5,
wherein the highest rate is the rate set by the user.

7. The network camera according to claim 1,
wherein the control unit controls the encoding bit rate in order to have the encoding bit rate to increase via a plurality of discontinuous points corresponding to threshold values of the data transmission rate with increase of the data transmission rate; and
wherein each of the threshold values are set to smaller as the remaining amount of the storage capacity of the storage unit becomes larger.

8. An operation control method of a network camera which can be connected to a network, comprising:
capturing an image of an object and generating image data;
encoding the image data;
storing the image data encoded by the image processing step in a storage unit; and
controlling an encoding bit rate at the image processing step based on a data transmission rate that the network has allowed for the network camera.

9. The operation control method according to claim 8,
wherein the control unit controls the encoding bit rate based on the data transmission rate and a remaining amount of storage capacity of the storage unit.

10. The operation control method according to claim 8, further comprising;
setting the encoding bit rate to a predetermined rate when the network camera is out of service range of the network and
controlling the encoding bit rate based on the data transmission rate when the network camera is within the service range of the network.

11. The operation control method according to claim 9, further comprising:
setting the encoding bit rate to the predetermined rate when the network camera is out of the service range of the network and
controlling the encoding bit rate according to the data transmission rate and the remaining amount of the storage capacity of the storing unit when the network camera is within the service range of the network.

12. The operation control method according to claim 8, further comprising:
notifying the highest rate of the encoding bit rate controlled to the network; and
making the upper limit of the data transmission rate that the network allows is set as the highest rate.

13. The operation control method according to claim 8,
wherein the highest rate is the rate set by the user.

14. The operation control method according to claim 8,
controlling the encoding bit rate in order to have the encoding bit rate to increase via a plurality of discontinuous points corresponding to threshold values of the data transmission rate with increase of the data transmission rate; and
wherein each of the threshold values are set to the smaller as the remaining amount of the storage capacity of the storage unit becomes larger.

15. (canceled)

16. A recording medium that records a program that makes a computer to execute the operation control method of the network camera that can be connected to a network, characterized by having a computer to execute:
an image capturing process for capturing an image of an object and generating image data;
an image process for encoding the image data;
a process for storing the image data encoded by the image process in a storage unit; and
a controlling process for controlling an encoding bit rate at the image process based on a data transmission rate that the network has allowed for the network camera.
